(19) United States
(12) Patent Application Publication
(10) Pub. No.: US 2021/0142259 A1
(43) Pub. Date: May 13, 2021

(54) EVALUATING SENSOR DATA TO ALLOCATE WORKSPACES TO WORKER ENTITIES BASED ON CONTEXT AND DETERMINED WORKER GOALS

(71) Applicant: International Business Machines Corporation, Armonk, NY (US)

(72) Inventors: Anup Kalia, Elmsford, NY (US); Jinho Hwang, Ossining, NY (US); Maja Vukovic, New York, NY (US); Komminist Weldemariam, Ottawa (CA)

(21) Appl. No.: 16/677,158

(22) Filed: Nov. 7, 2019

(51) Int. Cl. G06Q 10/06

(52) U.S. Cl. CPC G06Q 10/063112; G06Q 10/06316

(57) ABSTRACT

Techniques regarding using a combination of goals and context to allocate workspaces to worker entities are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise a data evaluating component that can evaluate data received from a data collection device associated with a task to be performed by a worker entity, and a goal determining component that can determine a goal of the worker entity for the task, based on the evaluated data. The system can further comprise a matching component that can select a workspace resource for the task based on the goal and a context of the task.

### BACKGROUND

The present invention relates generally to computer-assisted allocation of resources and services, and more particularly to methods and systems of using a combination of data sources to allocate workspaces to worker entities.

There is an emerging trend in the mobility of workers, entrepreneurs, and the people in general. Mobility workspaces are being made available for workers at firms of all sizes. Workplace culture is undergoing a transformation due to several factors, including the advancement of Internet and computing technologies and the availability of extra space in urban areas based on the shift of buying activity from in-person to online. Other factors driving these trends include digital content that can allow individuals to accomplish certain work items without going to a traditional workplace, and an increasing appreciation by firms of all sizes that this significant benefit for workers can also result in significant savings in overhead costs. One aspect that can be causing this transformation is the increasing availability of a broad variety of workspace settings and useful services for workers, from which workers can choose. In addition, the definition of a worker using a physical workspace has expanded for many types of work to include worker entities that can be a computer, an automated process with physical characteristics, e.g., robotics and/or a human.

With the increase in the types of work that be performed remotely comes an increase in the different requirements that are inherent in the different types of work. More workers, each performing a variety of work items with a variety of different requirements can cause problems, both for the workers in their need for particular combinations of features at particular times, and the needs of providers to determine which combinations of services to offer at particular times. The increasing number and variety of workspaces is also combined with a need by both workers and firms for short-term commitments to using workspaces, e.g., workspace usage commitments that used to be for years, can now be for only hours or minutes. While this flexibility can be useful for both workers and workspace providers it can also cause problems for both sides. For example, with more workers seeking increasingly specific types of workspaces for shorter terms, shortages of workspaces can occur, and the variety of different workspaces can make the frequent selection by workers of new workspaces more challenging.

Many of the traditional approaches to selecting and allocating workspaces were developed back when large firms negotiated long term commitments for use of generic spaces by large blocks of similar workers performing similar tasks. Because these traditional approaches are frequently not dynamic and flexible enough to handle many of the new demands from workers requesting workspaces and workspace providers, additional approaches have been developed. While these approaches can often handle the increasing demand for rapidly secured, short term use of workspaces, they still retain a limited consideration of the objectives and preferences of individual worker entities. In addition, conventional systems still rely much on manually entered data, with no automated processes for using sensors to gather useful information about workers, and providers.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later.

According to an embodiment, a system can comprise a memory that stores computer executable components and a processor that executes computer executable components stored in the memory, with the computer executable components comprising a data evaluating component that can evaluate data received from a data collection device associated with a task to be performed by a worker entity. The computer-executable components can further comprise a goal determining component that can determine a goal of the worker entity for the task, based on the evaluated data. Further, a matching component can select a workspace resource for the task based on the goal and a context of the task. The system can have a number of advantages, including that the goal determining component can more accurately determine goals of a worker for a task by integrating data from a variety of different sources with data collected from a data collection device associated with the worker. Further, traditional simple matching approaches, in many circumstances, will not compare with the result of the matching component noted above, e.g., this component improving the quality of workspace selection based on matching a combination of goals of the worker and context of the performance of the task.

According to yet another embodiment, a computer implemented method can comprise analyzing, by a device operatively coupled to a processor, data received from a data collection device, associated with a task to be performed by a worker entity. The computer-implemented method can further comprise determining, by the device, a goal of the worker entity for the task. The computer-implemented method can further comprise storing, by the device, the determined goal on a storage device, and selecting, by the device, a workspace resource for the task based on the stored goal and a context of the task.

The method can have a number of advantages, including more accurately determining goals of a worker for a task by integrating data from a variety of different sources, and a matching component that can improve the quality of workspace selection based on matching a combination of goals of the worker and context of the performance of the task. The method can have a number of advantages, including that the goal determining component can more accurately determine goals of a worker for a task by integrating data from a variety of different sources with data collected from a data collection device associated with the worker. Further, traditional simple matching approaches, in many circumstances, will not compare with the result of the matching component noted above, e.g., this component improving the quality of workspace selection based on matching a combination of goals of the worker and context of the performance of the task.

According to another embodiment, a computer program product that can facilitate selecting workspace resources can comprise a computer readable storage medium having program instructions embodied therewith, the program instructions executable by a processor to cause the processor to analyze data received from a data collection device, associated with a task to be performed by a worker entity. The instructions can further cause the processor to determine a goal of the worker entity for the task. The instructions can further cause the processor to store, by the device, the determined goal on a storage device, and to select a workspace resource for the task based on the stored goal and a context of the task.

The computer program product can have a number of advantages, including that the goal determining component can more accurately determine goals of a worker for a task by integrating data from a variety of different sources with data collected from a data collection device associated with the worker. Further, traditional simple matching approaches, in many circumstances, will not compare with the result of the matching component noted above, e.g., this component improving the quality of workspace selection based on matching a combination of goals of the worker and context of the performance of the task.

### BRIEF DESCRIPTION OF THE DRAWINGS

FIG. 1 illustrates a block diagram of an example, non-limiting system that can facilitate using a combination of goals and context to allocate workspaces to worker entities, in accordance with one or more embodiments described herein.

FIG. 2 illustrates a block diagram of an example of a non-limiting system that can facilitate using a combination of goals and context to allocate workspaces to worker entities, in accordance with one or more embodiments.

FIG. 3 illustrates a block diagram of an example of a non-limiting system that can facilitate using a combination of goals and context to allocate workspaces to worker entities, in accordance with one or more embodiments.

FIG. 4 illustrates a block diagram of an example of a non-limiting system that can facilitate using a combination of goals and context to allocate workspaces to worker entities, in accordance with one or more embodiments.

FIG. 5 illustrates a block diagram of an example of non-limiting system that can facilitate using a combination of goals and context to allocate workspaces to worker entities, in accordance with one or more embodiments.

FIG. 6 illustrates an implementation of an example of a non-limiting system that can facilitate using a combination of goals and context to allocate workspaces to worker entities by employing artificial intelligence/machine learning (AI/ML) components, in accordance with one or more embodiments described herein.

FIG. 7 illustrates a flow diagram of an example, non-limiting method that can facilitate using a combination of goals and context to allocate workspaces to worker entities, in accordance with one or more embodiments described herein.

FIG. 8 depicts a cloud computing environment in accordance with one or more embodiments described herein.

FIG. 9 depicts abstraction model layers in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or applications or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. It is noted that the drawings of the present application are provided for illustrative purposes only and, as such, the drawings are not drawn to scale. It should be appreciated that the embodiments of the subject disclosure depicted in various figures disclosed herein are for illustration only, and as such, the architecture of such embodiments are not limited to the systems, devices, and/or components depicted therein.

Workspace allocation techniques can enable worker entities to receive a list of available workspace resources for selection. Conventional approaches attempt to provide a good match by prompting for search criteria from worker entities. Unfortunately, these conventional systems perform searches based very narrow search criteria. By expanding search criteria to include task and employer characteristics combined with data from external sources and data collection devices (e.g., handheld devices, such as smart phones), one or more embodiments can improve the allocation of workspaces. Moreover, as described herein, one or more embodiments can employ a variety of approaches and data sources to determine a goal of a worker for a task, and can use this determined goal to improve the selection of workspaces for performance of the task by the worker.

As noted in the Background section above for many types of work the definition of a worker using a physical workspace has expanded to include worker entities that can be a computer, an automated process with physical characteristics and/or a human. Thus, as used herein, worker entities are described as being matched with physical workspaces, and as discussed herein, this can refer to both a computer, a human worker or a worker machine, e.g., a robot or other automated processes that can use a discrete, physical workspace.

The computer processing systems, computer-implemented methods, apparatus and/or computer program products that can be used to implement parts of some embodiments, can employ hardware and/or software to solve problems that are highly technical in nature (e.g., analyzing large sets of data, determining goals for as worker for a task, and matching goals and context to identify workspaces), that are not abstract, and that cannot be performed as a set of mental acts by a human. An individual, or even a plurality of individuals, cannot, for example, readily generate linkages between worker goals and workspace characteristics with the same efficiency as the embodiments described herein. Further, an individual cannot readily collect and analyze large amounts of data over time in the manner described herein.

FIG. 1 illustrates a block diagram of an example 100 of non-limiting system 102 that can facilitate using a combination of data sources to allocate workspaces to worker entities, in accordance with one or more embodiments. Repetitive description of like elements employed in other embodiments described herein is omitted for sake of brevity. Aspects of systems (e.g., system 102 and the like), apparatuses or processes in various embodiments of one or more embodiments can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 1, some embodiments can comprise a system 102 that can facilitate using a combination of data sources to allocate workspaces to worker entities. System 102 can be communicatively coupled, via network 190, to worker entity 191, data sources 192, and workspace provider 195. In some embodiments, system 102 can comprise memory 104, processor 106, and computer-executable components 110, communicatively connected to bus 112. In one or more embodiments, computer-executable components 110 can include data evaluating component 107, goal determining component 108, matching component 118, and any other components associated with system 102 that can use a combination of data sources to allocate workspaces to worker entities, as disclosed herein.

According to multiple embodiments, memory 104 can store one or more computer and/or machine readable, writable, and/or executable components and/or instructions that, when executed by processor 106, can facilitate performance of operations defined by the executable component(s) and instruction(s). For example, memory 104 can store computer and otherwise machine readable, writable, and/or executable components and/or instructions that, when executed by processor 106, can facilitate execution of the various functions described herein relating to system 102, data evaluating component 107, goal determining component 108, matching component 118, and any other components associated with system 102 as described herein, with or without reference to the various figures of the subject disclosure.

In some embodiments, memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), erasable programmable ROM (EPROM), electrically erasable programmable ROM (EEPROM), etc.) that can employ one or more memory architectures. Further examples of memory 104 are described below with reference to system memory 1006 and FIG. 10. Such examples of memory 104 can be employed to implement any embodiments of the subject disclosure.

According to multiple embodiments, processor 106 can comprise one or more types of processors and/or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or a combination of different central processing units, multi-core processors, microprocessors, dual microprocessors, microcontrollers, Systems on a Chip (SOC), array processors, vector processors, and any other type of processor. Further examples of processor 106 are described below with reference to processing unit 1004 and FIG. 10. Such examples of processor 106 can be employed to implement any embodiments of the subject disclosure.

In some embodiments, elements of system 102, including, but not limited to memory 104, processor 106, data evaluating component 107, goal determining component 108, matching component 118, and any other component of system 102 as described herein, can be communicatively, electrically, and/or operatively coupled to one another via bus 112 to perform functions of system 102, and any other components coupled therewith. In several embodiments, bus 112 can comprise one or more of a memory bus, memory controller, peripheral bus, external bus, local bus, or another type of bus that can employ various bus architectures. Further examples of bus 112 are described below with reference to system bus 1008 and FIG. 10. Such examples of bus 112 can be employed to implement any embodiments of the subject disclosure.

In some embodiments, system 102 can comprise any type of component, machine, device, facility, apparatus, and/or instrument that comprises a processor and/or can be capable of effective and/or operative communication with a wired and/or wireless network. All such embodiments are envisioned. For example, system 102 can comprise a server device, a computing device, a general-purpose computer, a special-purpose computer, a quantum computing device (e.g., a quantum computer, a quantum processor, etc.), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

In some embodiments, system 102 can be coupled (e.g., communicatively, electrically, operatively, etc.) to one or more external systems, sources, and/or devices (e.g., computing devices, communication devices, etc.) via a data cable (e.g., coaxial cable, High-Definition Multimedia Interface (HDMI), recommended standard (RS) 232, Ethernet cable, etc.). In some embodiments, system 102 can be coupled (e.g., communicatively, electrically, operatively, etc.) to one or more external systems, sources, and/or devices (e.g., computing devices, communication devices, etc.) via a network. It should be noted that, while system 102 is illustrated in FIG. 1, in other embodiments, multiple devices of various types can be associated with or comprise the features shown in FIG. 1. Further, system 102 can include components that communicate with one or more cloud computing environments, e.g., discussed with FIGS. 8-9 below.

As noted above, according to multiple embodiments, system 102 can comprise computer-executable components 110. As described herein, computer-executable components 110 can comprise one or more computer and/or machine readable, writable, and/or executable components and/or instructions that, when executed by processor 106, can facilitate performance of operations defined by such component(s) and/or instruction(s). Further, in numerous embodiments, any component associated with system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, data evaluating component 107, goal determining component 108, matching component 118, and any other components associated with system 102 as disclosed herein (e.g., communicatively, electronically, and/or operatively coupled with and/or employed by system 102), can comprise such computer and/or machine readable, writable, and/or executable component(s) and/or instruction(s). Consequently, according to numerous embodiments, system 102 and/or any components associated therewith as disclosed herein, can employ processor 106 to execute such computer and/or machine readable, writable, and/or executable component(s) and/or instruction(s) to facilitate performance of one or more operations described herein with reference to system 102 and/or any such components associated therewith.

Generally speaking, one or more embodiments can facilitate identifying one or more workspace resources based on a goal of worker entity 191 for the task and a context of the task, received or derived from a worker and combinations of data sources, including data of worker entity 191 collected by data collection device 197. In one or more embodiments, because in some circumstances, workers can be searching to reserve use of a workspace for a period of time, a workspace resource can describe the combination of a period of time and a location. In further embodiments, workspace resource can further include resources that can be used during the particular time at the workspace. For example, a worker can need a particular workspace during a particular time, with a projector and conference table, e.g., the workspace, the time period, the projector, and the conference table are the workspace resource sought to be allocated to the requestor. For example, in one or more embodiments, goal determining component 108 can analyze a request for a workspace resource, and based on this analysis, to determine request factors of the request, e.g., a requested time along with the projector and conference room requirements noted above. Continuing this example, in one or more embodiments, matching component 118 can select the workspace resource based on the request factor determined by the goal determining component 108. Different approaches worker goals and task context to generate matches by matching component 118 are discussed with FIG. 2 below. After workspace results are provided, and a preliminary selection is made, FIG. 3, discussed below shows how system 102 can perform automatic negotiation and contract generation for use of the selected workspace. FIG. 4 provides examples of how data sources can be used to determined worker goals and task context, as described above, to provide more useful results than use of a basic request for a workspace, e.g., as is done with conventional approaches.

FIG. 2 illustrates a block diagram of an example 200 of non-limiting system 102 that can facilitate using a combination of data sources to allocate workspaces to worker entities, in accordance with one or more embodiments. Repetitive description of like elements employed in other embodiments described herein is omitted for sake of brevity. As shown in FIG. 2, some embodiments can comprise a system 102 that, in some embodiments, can be communicatively coupled, via network 190, to worker entity 191, data sources 192, and workspace provider 195. System 102 can comprise memory 104, processor 106, and computer-executable components 110, communicatively connected to bus 112. In one or more embodiments, computer-executable components 110 can include data evaluating component 107, goal determining component 108, matching component 118, allocating component 210, and any other components associated with system 102 and using a combination of data sources to allocate workspaces to worker entities, as disclosed herein.

In one or more embodiments, characteristics of work items to be performed can also have requirements, e.g., conditions for performance of the work item by a worker. In other embodiments, a goal for a worker entity can include restrictions on workspace environments. These requirements can be preferences of the worker, or conditions needed to perform the work item. As noted above, in one or more embodiments, goal determining component 108 can consider different restrictions when determining a goal of worker entity 191 for the task, based on received data evaluated by data evaluating component 107. In addition, one or more embodiments can include these types of requirements as characteristics of a workspace resource that can be used for matching, e.g., by matching component 118. In an alternative approach to utilizing restrictions, certain requirements can be mapped to conditions of a workspace and used to provide extra factors for workspace selection. For example, if a worker request includes a quiet workspace as a requirement, one or more embodiments can incorporate this as a factor in the search, and only workspaces that have this characteristic can be returned. Other requirements for workspaces include, but are not limited to, a phone to be used for conversation with remote co-worker/client, and speed characteristics of the communication network serving the workspace.

In one or more embodiments, a worker, an administrator, or another involved party can manually provide the above characteristics to the system. In alternative embodiments, characteristics of work items can be derived from historical information of the work item, the worker, the workplace, or other sets of data about past work items. One approach to this derivation is to employ processes that use artificial intelligence and machine learning (AI/ML) techniques to learn different characteristics of the above-noted sets of work item data. FIG. 6, and the discussion of such below, provide descriptions of some types of AI/ML that can be employed by one or more embodiments, as well as example implementations of AI/ML for a variety of different processed described herein. Alternatively, characteristics of a work items can also be automatically retrieved from a repository of work item information. For example, the system can maintain a catalog of requirements entered and derived over time. Further, in addition to this catalog of combinations of work items, worker characteristics, and requirements, results can also be stored for these combinations. In one or more embodiments, this catalog can provide additional information to be analyzed by goal determining component 108 when a goal of the worker for performance of the task is determined.

In one or more embodiments, combinations of different entities can also have characteristics. For example, when a worker is set to work or working on a work item, the worker can have a goal associated with the work item, e.g., the technical, business and objects of the worker's ambition or effort, including a desired result for the completion of the work item. As discussed further below, one or more embodiments, can use a goal of a worker with respect to a work item as factor that can be used as a request factor for use in selecting workspaces.

Additional characteristics that can be used by one or more embodiments include, consideration, not only of the worker entity, but also the employer of the worker entity, e.g., the type of firm, such as a product or services firm. Embodiments can also use, as a request factor, the stage of development of the firm, e.g., whether the firm is a startup and the maturity of the work of the firm. In one or more embodiments, different characteristics of the employer firm can affect other factors, e.g., the goals of the worker entities, as described above.

Returning to the example operation of computer-executable components 110 described above, additional details of example implementations of matching component 118 are provided below. In one or more embodiments, before the matching process, components of system 102 can generate a request payload, comprising matchmaking factors, a preferred list of mobile workplace locations, proposed pricing requirements, e.g., desired and maximum amounts paid for different combination of features. For example, when requesting a match, a worker can request a combination of features (e.g., location, network speeds, common areas), and a desired and maximum price can be included with the request, e.g., so these price values can be included in the matching operations perform, e.g., by matching component 118.

Continuing this example, in one or more embodiments, the initial request payload can be reviewed and approved by a mobile user or users. Further, based on this review, one or more of the request payload values can be modified (feedback) by the user or group of users. The system then can trigger matching component 118 to determine an initial set of suitable workplaces.

In this example, with a worker goal (e.g., generated by goal determining component 108), matching component 118 can preforms matching by progressively evaluating specific mobile workspaces in view of the determined goals of the worker entities, a context of performance of the task, and other information. In particular, specific mobile workspaces that satisfy one or more conditions can be evaluated, e.g., certain selected requirements noted above can be applied to narrow down the field of workspaces to be considered by one or more embodiments.

One approach that matching component 118 can use to apply determined goals and context to identify workspaces can use statistical correlations analysis, and can then allow refactoring of matchmaking factors and workplaces into narrower “factors” and relevant properties/constraints for those workplaces or locations that have recommendations to maximum a user or group effectiveness for the specific classes of goals.

Once narrowed down, the set of recommended mobile workplaces can be presented to a user on a GUI for the user to make selection, provide feedback, and input additional constraints, e.g., so that system 102 can re-learn and generate a secondary set of recommended mobile workplaces based on the analysis of the feedback.

FIG. 3 illustrates a block diagram of an example 300 of non-limiting system 102 that can facilitate using a combination of data sources to allocate workspaces to worker entities, in accordance with one or more embodiments. Repetitive description of like elements employed in other embodiments described herein is omitted for sake of brevity. As shown in FIG. 3, some embodiments can comprise a system 102 that can be communicatively coupled, via network 190, to worker entity 191, data sources 192, and workspace provider 195. System 102 can comprise memory 104, processor 106, and computer-executable components 110, communicatively connected to bus 112. In one or more embodiments, computer-executable components 110 can include data evaluating component 107, goal determining component 108, matching component 118, allocating component 210, costing component 310, contracting component 320, acknowledging component 330, AI/ML component 373, and any other components associated with system 102 and using a combination of data sources to allocate workspaces to worker entities, as disclosed herein.

In one or more embodiments, contracting component can negotiate contract terms for workspace allocation automatically, with the workspace provider. Consider an agent A and B have strategies S_a and S_b and respective utilities u_a and u_b, the maximum value for agent A is given by max_(s_a in S_a) min_(s_b in S_b) u_a(s_a, s_b). This means agent A tries chose the strategy that maximizes its utility u_a taking into account that agent B tries to minimize its utility. This approach enables agents generate offers and counteroffers at each iteration based on different factors.

When this formula is true, this can signify to one or more embodiments have maximized the utility of the agreement, even while an agent of the workplace provider tries to minimize its utility.

Optionally, in additional embodiments, through dynamic payment generation and the blockchain service discussed with FIG. 5 below (or other, conventional payment approaches), workplace owners can be remunerated according to the negotiated contract for providing workplaces and other associated services.

In one or more embodiments discussed with FIG. 5 below, based on the negotiation process described above, system 102 can establish a contractual agreement between the mobile worker and a workspace provider, using blockchain. A contractual agreement associated with the usage can include an agreed upon requested payload along with terms and conditions for the booking. This storage of contractual data in a shared format, but with tamper-resistant feature can, in some circumstances, set up an advantageous balance, as compared with conventionally logged systems. between accessibility and security. In one or more embodiments, upon establishing a contractual agreement, acknowledging component 330 can provide notifications to respective parties.

FIG. 4 illustrates a block diagram of an example 400 of non-limiting system 102 that can facilitate using a combination of data sources to allocate workspaces to worker entities, in accordance with one or more embodiments. Repetitive description of like elements employed in other embodiments described herein is omitted for sake of brevity. As shown in FIG. 4, some embodiments can comprise an expanded view of data source 192 coupled to worker entity 191, workspace provider 195, workspace 450, and system 102. FIG. 4 depicts a simplified diagram of system 102 that comprises computer-executable components that comprise data collecting component 430 and matching component 118.

Data sources 192 depicts a non-limiting collection of data sources, one or more of which can be used in combination with other sources not depicted, for various functions of embodiments described below. Notwithstanding the depiction as a single component, any combination of data sources 192 can be hosted on any combination of computing devices, as would be appreciated. Data sources 192 includes, but is not limited to, social media 410A, location information 410B, public ratings 410C, records 410D, work assignments 410E, news 410F, workspace condition profiles 410G, and project manager 410H.

In an example implementation, system 102 can run in the background of a plurality of systems (e.g., of a user electronic calendar system, and project management tools such as GITHUB®, etc.) or run as independent app on a user device (e.g., a mobile phone). Using this embodiment, a worker can enter a time that a workspace is needed, and a context for task performance can comprise this time frame, for queries. To augment and improve matchmaking factors, the disclosed matchmaking system can collect a plurality of data points such as type of work and work items, profiles, preferences, historical workplaces used, calendar, user social graphs, location, user's cognitive (e.g., mood) and affective signals (e.g., using various native and instrumented sensors on a mobile device), as well as infer/model the user states from multiple heterogeneous inputs on a tablet/mobile and recommend suitable workspaces by employing heuristics and machine learning algorithms.

In one or more embodiments, social media 410A, can be queried by data collecting component 430, to provide data to goal determining component 108 to be used to determine a goal of the worker for the task. Social media 410A servers include one or more social media platforms. For example, social media 410A servers can include servers hosting or providing access (e.g., through a public API, etc.) to social networks. Each social media platform provides its members with the ability to create profiles, make social media posts, and optionally to make connections with each other. Members can be people, corporations, or other entities. Further, a social media platform of social media servers can provide access to a member's history of past social media posts. When a member of a social media platform makes a new social media post, the new social media post is appended to the member's history, and also made public, or semi-public, depending on settings stored in the member's profile. Generally, a social media post can include text or other media (e.g., a picture, etc.) on any topic.

In one or more embodiments, multiple social media 410A networks can be accessed, e.g., by data collecting component 430, and information about different workspaces can be accessed, including user posts, discussions, previous experience on the use of a workspace or services offered at the workplace, data from location information 410B service. Further, one or more embodiments can characterize and organize mobile workplace profiles according to the attributes mentioned above (e.g., time of availability, types of individuals or crowd presence as a function of time of the day, level of security and privacy, proximity, etc.) for efficient searching and matchmaking given one or more workspace matchmaking factors of a mobile worker.

In one or more embodiments, location information 410B, can be queried by data collecting component 430, to provide data to goal determining component 108 to be used to determine a goal of the worker for the task and provide information for matching component 118 to select from available workspaces. For example, or more embodiments can use location information 410B websites to retrieve information about workspace locations, worker residences (e.g., for commuting time), weather statistics, weather information (e.g., current and at forecasts for the time the work is sought to be performed), and other data. This data, like other data used for matching can be compared to worker preferences to assist with matching.

In one or more embodiments, public ratings 410C, can be queried by data collecting component 430, to provide data to goal determining component 108 to be used to determine a goal of the worker for the task. Public ratings 410C websites can be repositories of ratings of different made by public users, and this data can be utilized by one or more embodiments to assess different workspaces, e.g., based on satisfaction levels of different users.

In one or more embodiments, records 410D, can be queried by data collecting component 430, to provide data to goal determining component 108 to be used to determine a goal of the worker for the task. In an example, worker entities can give access to records so as to give matching component 118 additional information to be used for matching. For example, user calendar information can be used to block out times where other commitments have been made, and bank account information can be used to assist in having an automated agent negotiate contracts for workspaces. Information from a worker's mobile phone can be used to determine favorite locations (e.g., for locating workspaces nearby), worker contacts (e.g., to determine what workspaces they have used),

In one or more embodiments, work assignments 410E, can be queried by data collecting component 430, to provide data to goal determining component 108 to be used to determine a goal of the worker for the task. As noted above, one or more embodiments can retrieve work assignments from work assignments 410E system to better match up workspaces, and further, to break down tasks into subtasks for selecting workspaces, e.g., different subtasks can have different requirements.

In one or more embodiments, news 410F, can be queried by data collecting component 430, to provide data to goal determining component 108 to be used to determine a goal of the worker for the task. In one or more embodiments, news 410F sites can provide useful past information (e.g., traffic near potential workspaces), current information (e.g., weather conditions near a workspace), and future predictions (e.g., news stories about new workspace development).

In one or more embodiments, workspace condition profiles 410G, can be queried by data collecting component 430, to provide data to goal determining component 108 to be used to determine a goal of the worker for the task. For example, one or more embodiments can create and maintain searchable crowdsourced mobile workplace data store. In one or more embodiments, the method of profiling the workplace can be related to associating the workplace with multiple attributes, such as time of availability, types of individuals or crowd presence (as a function of time of the day), connectivity strength (e.g., the Internet), level of security and privacy, profile of surrounding or nearby ambient noise, proximity.

In one or more embodiments, project manager 410H, can be queried by data collecting component 430, to provide data to goal determining component 108 to be used to determine a goal of the worker for the task. For example, as noted above, because the worker and employer have traditionally been the prime selector of workspaces, aspects of these can be used as criterial for use in selecting workspaces by matching component 118 for different embodiments. In an approach can have better results in some circumstances than employer preferences alone, goal determining component 118 can determine a goal for the work by decomposing the overall objective of the mobile worker into tasks and subtasks. Subtasks can then have goals determined for them, e.g., based on the subtask, the overall goal for the task, and historical information for factors including, but not limited to, past performance of the task by other worker entities, past performance of other tasks by the worker, and relationship of the subtask to the main task. This can be performed by one or more embodiments by a combination of one or more of a variety of approaches that can include, but are not limited to, receiving input from the worker, accessing, as one of data sources 192, project manager 410H system, to retrieve task types and other data.

Thus, in one or more embodiments, given a set of current work items and goals for a given mobile worker, the system can automatically determine goals and context based distinct properties associated with each work item. This has advantages over conventional approaches because, in some circumstances, combining both task requirements with worker and employer requirements means that searches can be more accurate. Because of the increases in accuracy, useful results can be obtained faster than with other approaches with less search criteria. As noted above, because workspaces are often used much more frequently and with more urgency, being able to get results faster can be a significant advantage over conventional approaches.

With tasks, as noted above, different requirements can be determined, e.g., based on input or retrieved from data sources or AI/MI. For example, different tasks can require quiet time and no distractions and an excellent WiFi connection, whilst others can require an ambience that can stimulates creativity.

FIG. 5 illustrates a block diagram of an example 500 of non-limiting system 102 that can facilitate using a combination of data sources to allocate workspaces to worker entities, in accordance with one or more embodiments. Repetitive description of like elements employed in other embodiments described herein is omitted for sake of brevity. As shown in FIG. 5, some embodiments can comprise a system 102 that can be communicatively coupled, via network 190, to worker entity 191, data sources 192, workspace provider 195, and blockchain node device 540 having blockchain ledger 520B. System 102 can comprise memory 104, processor 106, computer-executable components 110, and blockchain component 530, communicatively connected to bus 112. Blockchain component 530 can comprise blockchain ledger 520A. In one or more embodiments, computer-executable components 110 can include goal determining component 108, matching component 118, allocating component 210, costing component 310, contracting component 320, AI/ML component 373, logging component 510, and any other components associated with system 102 and using a combination of data sources to allocate workspaces to worker entities, as disclosed herein.

In particular, blockchain component 530 can be used to create a tamper-proof record for storage of the one or more smart contracts noted above. to track, store and manage transactions (e.g., the request, booking, contract negotiation, check-in/check-out, events, etc.) Further, in one or more embodiments, as the blockchain service invokes the one or more smart contracts associated with expected one or more learning outputs to help validate the service level agreements, with stored or dynamically composed consents, as well as to determine the specific selected learning outputs and activities that all parties (e.g., mobile works, owners of mobile workplaces, payment gateways, agents) predicted to comply with at a specified time period.

In one or more embodiments, when the mobile worker is checked out of an allocated workspace, system 102 can relay the completion information to the blockchain service. The smart contract and the consensus protocol in the blockchain mobile worker-mobile workplace service level agreement can facilitate the payment as specified in the request payload (e.g., paying using cryptocurrencies on blockchain). The smart contract on the blockchain service then optionally sends alerts (or tokens) for each party.

FIG. 6 illustrates an implementation of an example 600 of non-limiting system 102 that can facilitate using a combination of data sources to allocate workspaces to worker entities by employing AI/ML components, in accordance with one or more embodiments described herein. Repetitive description of like elements employed in other embodiments described herein is omitted for sake of brevity. As depicted in FIG. 6, system 102 can comprise computer-executable components 110, artificial neural network (ANN) 670, and training data 610. Computer-executable components 110 can comprise AI/ML component 373 communicatively coupled to training data 610 and ANN 670.

In certain embodiments, different functions of AI/ML can be facilitated based on classifications, correlations, inferences and/or expressions associated with principles of artificial intelligence. For example, AI/ML component 373 can employ expert systems, fuzzy logic, SVMs, Hidden Markov Models (HMMs), greedy search algorithms, rule-based systems, Bayesian models (e.g., Bayesian networks), ANNs, other non-linear training techniques, data fusion, utility-based analytical systems, systems employing Bayesian models, and ensemble ML algorithms/methods, including deep neural networks (DNN), reinforcement learning (RL), Bayesian Statistics, long short-term memory (LSTM) networks.

Example outputs of AI/ML components can include request factors identified from combinations of data sources, and matches between combinations of request factors and workplaces. In an example AI/ML approach that can be utilized by one or more embodiments, ANN 670 can be optimized (also termed “trained” herein) by submitting optimizing data (e.g., training data 610) to ANN 670, e.g., request factors and matched combinations of worker entities and workplaces, along with satisfaction ratings for the matches. It should be noted that this description of employing an ANN is non-limiting, e.g., one or more embodiments can use other types of machine learning algorithms that receive input and perform analysis, e.g., slice history 377, as described above.

An example implementation of AI/ML components can employ a Bayes Network or Markov network that can model elements including, but not limited to, network elements and a distributed network of models. A network dependency graph could be built that models the network and physical and virtual or separate and the dependencies between graph nodes.

In a variation of the above approach, in other embodiments, failure probabilities can be generated by one or more embodiments for each node, and can be store for reference. Based on this, during prediction by AI/ML components 373, alarms and network status information can be combined to infer root causes of delays or failures of the network. Routing or other network configurations can then be made to maintain SLA performance.

As used herein, the term “neural network model” can refer to a computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Neural network models can learn through training, wherein data with known outcomes is inputted into the computer model, outputs regarding the data are compared to the known outcomes, and/or the weights of the computer model are autonomous adjusted based on the comparison to replicate the known outcomes.

As used herein, the term “training data” can refer to data and/or data sets used to train one or more neural network models. As a neural network model trains (e.g., utilizes more training data), the computer model can become increasingly accurate; thus, trained neural network models can accurately analyze data with unknown outcomes, based on lessons learning from training data, to facilitate one or more machine learning tasks. Example neural network models can include, but are not limited to: perceptron (“P”), feed forward (“FF”), radial basis network (“RBF”), deep feed forward (“DFF”), recurrent neural network (“RNN”), long/short term memory (“LSTM”), gated recurrent unit (“GRU”), auto encoder (“AE”), variational AE (“VAE”), denoising AE (“DAE”), sparse AE (“SAE”), Markov chain (“MC”), Hopfield network (“HN”), Boltzmann machine (“BM”), deep belief network (“DBN”), deep convolutional network (“DCN”), deconvolutional network (“DN”), deep convolutional inverse graphics network (“DCIGN”), generative adversarial network (“GAN”), liquid state machining (“LSM”), extreme learning machine (“ELM”), echo state network (“ESN”), deep residual network (“DRN”), kohonen network (“KN”), support vector machine (“SVM”), and/or neural Turing machine (“NTM”).

FIG. 7 illustrates a flow diagram of an example, non-limiting method 700 that can facilitate using a combination of data sources to allocate workspaces to worker entities in response to a request, in accordance with one or more embodiments described herein. Repetitive description of like elements employed in other embodiments described herein is omitted for sake of brevity.

At 702, the method 700 can comprise analyzing, by a device operatively coupled to a processor, data received from a data collection device, associated with a task to be performed by a worker entity. For example, in some embodiments, a method can comprise analyzing (e.g., by data evaluating component 107), by a device (e.g., a device of system 102) operatively coupled to a processor 106, data (e.g., data from worker entity 191) received from a data collection device 197, associated with a task to be performed by a worker entity 191.

At 704, the method 700 can comprise determining, by the device, a goal of the worker entity for the task, based on the analyzing the data. For example, in some embodiments, a method can comprise determining, by the device (e.g., a device of system 102), a goal of the worker entity 191 for the task, based on the analyzing (e.g., by data evaluating component 107) the data (e.g., data from worker entity 191).

At 706, the method 700 can comprise selecting, by the device, a workspace resource for the task based on the goal and a context of the task. For example, in some embodiments, the method can comprise selecting (e.g., by matching component 118), by the device (e.g., a device of system 102) operatively coupled to a processor 106, a workspace resource for the task based on the goal and a context of the task. The above described method can have advantages over the conventional approaches based at least on the operations of data evaluating component 107, and goal determining component 108 to determine a goal of the worker for matching with workspaces, e.g., by matching component 118.

FIG. 8 depicts an example cloud computing environment 800, within which one or more embodiments can use cloud components that can distribute functions throughout the cloud computing environment. It is to be understood that although this disclosure includes a detailed description on cloud computing, implementation of the teachings recited herein are not limited to a cloud computing environment. Rather, some embodiments described herein can be capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics include on-demand self-service components, e.g., a cloud consumer can unilaterally provision computing capabilities, such as server time and network storage, as needed automatically without requiring human interaction with the service's provider.

Characteristics can further include broad network access, e.g., capabilities are available over a network and accessed through standard mechanisms that promote use by heterogeneous thin or thick client platforms (e.g., mobile phones, laptops, and PDAs).

Characteristics can further include resource pooling, e.g., the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Characteristics can further include rapid elasticity, e.g., capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Characteristics can further include measured service, e.g., cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models can include software as a service (SaaS), e.g., the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Service models can further include platform as a service (PaaS), e.g., the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Service models can further include infrastructure as a service (IaaS), e.g., the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models can include a organization cloud, e.g., the cloud infrastructure is operated solely for an organization. It can be managed by the organization or a third party and can exist on-premises or off-premises. Deployment models can further include a community cloud, e.g., the cloud infrastructure is shared by several organizations and supports a specific community that has shared concerns (e.g., mission, security requirements, policy, and compliance considerations). It can be managed by the organizations or a third party and can exist on-premises or off-premises.

Deployment models can further include a public cloud, e.g., the cloud infrastructure is made available to the general public or a large industry group and is owned by an organization selling cloud services. Deployment models can further include a hybrid cloud, e.g., the cloud infrastructure is a composition of two or more clouds (organization, community, or public) that remain unique entities but are bound together by standardized or proprietary technology that enables data and application portability (e.g., cloud bursting for load-balancing between clouds).

A cloud computing environment can be service oriented with a focus on statelessness, low coupling, modularity, and semantic interoperability. As discussed below, cloud computing can rely on aspects of an infrastructure that can include a network of interconnected nodes.

FIG. 8 depicts illustrative cloud computing environment 800. As shown, cloud computing environment 800 includes one or more cloud computing nodes 802 with which local computing devices used by cloud consumers, such as, for example, digital assistant (PDA) or cellular telephone 804, desktop computer 806, laptop computer 808, and/or automobile computer system 810 can communicate. Nodes 802 can communicate with one another. They can be grouped (not shown) physically or virtually, in one or more networks, such as Organization, Community, Public, or Hybrid clouds as described hereinabove, or a combination thereof. This allows cloud computing environment 800 to offer infrastructure, platforms and/or software as services for which a cloud consumer does not need to maintain resources on a local computing device. It is understood that the types of computing devices 804-810 shown in FIG. 8 are intended to be illustrative only and that computing nodes 802 and cloud computing environment 800 can communicate with any type of computerized device over any type of network and/or network addressable connection (e.g., using a web browser).

Referring now to FIG. 9, a set of functional abstraction layers provided by cloud computing environment 800 of FIG. 8 is shown. Repetitive description of like elements employed in other embodiments described herein is omitted for sake of brevity. It should be understood in advance that the components, layers, and functions shown in FIG. 9 are intended to be illustrative only and embodiments of the invention are not limited thereto. As depicted, the following layers and corresponding functions are provided.

Hardware and software layer 902 includes hardware and software components. Examples of hardware components include: mainframes 904; RISC (Reduced Instruction Set Computer) architecture based servers 906; servers 908; blade servers 910; storage devices 912; and networks and networking components 914. In some embodiments, software components include network application server software 916 and database software 918.

Virtualization layer 920 provides an abstraction layer from which the following examples of virtual entities can be provided: virtual servers 922; virtual storage 924; virtual networks 926, including virtual private networks; virtual applications and operating systems 928; and virtual clients 930.

In one example, management layer 932 can provide the functions described below. Resource provisioning 934 provides dynamic procurement of computing resources and other resources that are utilized to perform tasks within the cloud computing environment. Metering and Pricing 936 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 938 provides access to the cloud computing environment for consumers and system administrators. Service level management 940 provides cloud computing resource allocation and management such that required service levels are met. Service Level Agreement (SLA) planning and fulfillment 942 provide pre-arrangement for, and procurement of, cloud computing resources for which a future requirement is anticipated in accordance with an SLA.

Workloads layer 944 provides examples of functionality for which the cloud computing environment can be utilized. Examples of workloads and functions which can be provided from this layer include data evaluating component 107, goal determining component 108 and matching component 118. Various embodiments described herein can utilize the cloud computing environment described with reference to FIGS. 10 and 9 to facilitate one or more of combining goals and context to allocate workspaces to worker entities, as described herein.

Embodiments described herein can be a system, a method, and/or a computer program product at any possible technical detail level of integration. The computer program product can include a computer readable storage medium (or media) having computer readable program instructions thereon for causing a processor to carry out aspects of some embodiments discussed herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of one or more embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of one or more embodiments.

Aspects of one or more embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

In order to provide additional context for various embodiments described herein, FIG. 10 and the following discussion are intended to provide a general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (“BIOS”) can be stored in a non-volatile memory such as ROM, erasable programmable read only memory (“EPROM”), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (“HDD”) 1014 (e.g., EIDE, SATA), one or more external storage devices 1016 (e.g., a magnetic floppy disk drive (“FDD”) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (“SSD”) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (“VM”) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (“TPM”). For instance, with a TPM, boot components hash next in time boot components, and wait for a match of results to secured values, before loading a next boot component. This process can take place at any layer in the code execution stack of computer 1002, e.g., applied at the application execution level or at the operating system (“OS”) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (“LAN”) 1054 and/or larger networks, e.g., a wide area network (“WAN”) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (“AP”) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor that executes the computer-executable components stored in the memory, wherein the computer-executable components comprise:
a data evaluating component that evaluates data received from a data collection device associated with a task to be performed by a worker entity;
a goal determining component that determines a goal of the worker entity for the task, based on the evaluated data; and
a matching component that selects a workspace resource for the task based on the goal and a context of the task.

2. The system of claim 1, wherein the computer-executable components further comprise an allocating component that allocates the workspace resource to the worker entity based on the selecting the workspace resource.

3. The system of claim 2, wherein the computer-executable components further comprise:
a costing component that identifies a resource cost for the allocating the workspace resource to the worker entity;
a contracting component that generates a contract comprising information identifying the workspace resource and the resource cost; and
an acknowledging component that receives an acknowledgement of the contract from the worker entity, wherein the allocating the workspace resource to the worker entity is based on the acknowledgement.

4. The system of claim 2, wherein the computer-executable components further comprise a logging component that stores allocation characteristics of the allocating the workspace resource in an append-only, tamper-resistant, shared ledger.

5. The system of claim 1, wherein the data collection device comprises a mobile device, and wherein the data received from a data collection device comprises sensor data of the worker entity collected from a sensor of the mobile device.

6. The system of claim 1, wherein the context comprises a requirement of workspace resources for completion of the task.

7. The system of claim 6, wherein the requirement of the workspace resources for the completion of the task comprises at least one of, an availability for a length of time, first connectivity with computing resources, second connectivity with human resources, or a level of security provided.

8. The system of claim 1, wherein the goal determining component determines the goal of the worker entity for the task over a period of time.

9. The system of claim 1, further comprising a neural network trained by sensor data from the matching component, wherein the matching component selects the workspace resource for the task further based on output of the neural network.

10. The system of claim 1, wherein the goal determining component determines the goal of the worker entity for the task based on social data collected from a social media data system.

11. The system of claim 1, wherein the workspace resource comprises:
a physical space, and
a time that the physical space is available for use to perform the task.

12. A computer-implemented method, comprising:
analyzing, by a device operatively coupled to a processor, data received from a data collection device, associated with a task to be performed by a worker entity;
determining, by the device, a goal of the worker entity for the task, based on the analyzing the data;
storing, by the device, the determined goal on a storage device; and
selecting, by the device, a workspace resource for the task based on the stored goal and a context of the task.

13. The computer-implemented method of claim 12, further comprising allocating the workspace resource to the worker entity based on the selecting the workspace resource.

14. The computer-implemented method of claim 13, further comprising:
identifying a resource cost for the allocating the workspace resource to the worker entity;
generating a contract comprising information identifying the workspace resource and the resource cost; and
receiving an acknowledgement of the contract from the worker entity, wherein the allocating the workspace resource to the worker entity is based on the acknowledgement.

15. The computer-implemented method of claim 13, further comprising storing allocation characteristics of the allocating the workspace resource in an append-only, tamper-resistant, shared ledger.

16. The computer-implemented method of claim 12, wherein the context comprises a requirement of workspace resources for completion of the task.

17. The computer-implemented method of claim 16, wherein the requirement of the workspace resources for the completion of the task comprises at least one of, an availability for a length of time, first connectivity with computing resources, second connectivity with human resources, or a level of security provided.

18. The computer-implemented method of claim 12, wherein the worker entity comprises a robotic device.

19. A computer program product facilitating selecting workspace resources, the computer program product comprising a computer readable storage medium having program instructions embodied therewith, the program instructions executable by a processor to cause the processor to:
analyze, by the processor, data received from a data collection device, associated with a task to be performed by a worker entity;
determine, by the processor, a goal of the worker entity for the task;
store, by the device, the determined goal on a storage device; and
select, by the device, a workspace resource for the task based on the stored goal and a context of the task.

20. The computer program product of claim 19, wherein the program instructions further cause the processor to allocate the workspace resource to the worker entity based on the instructions to select the workspace resource.
